(19) United States
(12) Patent Application Publication
(10) Pub. No.: US 2013/0036043 A1
(43) Pub. Date: Feb. 7, 2013

(54) IMAGE-BASED PRODUCT MAPPING

(71) Applicant: Patrick Faith, Pleasanton, CA (US)

(72) Inventor: Patrick Faith, Pleasanton, CA (US)

(21) Appl. No.: 13/542,942

(22) Filed: Jul. 6, 2012

Related U.S. Application Data
(60) Provisional application No. 61/504,860, filed on Jul. 6, 2011.

(51) Int. Cl. G06Q 40/02; H04W 24/00; G06K 9/60

(52) U.S. Cl. 705/39; 382/305; 455/456.1

(57) ABSTRACT

Methods, systems, computer-readable media, and apparatuses for image-based product mapping are presented. In some embodiments, a server computer may receive, from a first computing device, a first image and information identifying a first location at which the first image was captured. The first image may include a first product. Subsequently, the server computer may receive, from a second computing device, a second image and information identifying a second location at which the second image was captured. The second image may include a second product, and the second location may be different from the first location. The server computer then may analyze the first image to identify the first product and the second image to identify the second product. Thereafter, the server computer may store, in at least one database, first information associating the first product with the first location, and second information associating the second product with the second location.

### CROSS-REFERENCE TO RELATED APPLICATIONS

This application claims the benefit of U.S. Provisional Patent Application Ser. No. 61/504,860, filed on Jul. 6, 2011, and entitled “SYSTEM AND METHOD FOR MAPPING ITEMS.” The foregoing application is incorporated by reference herein in its entirety for all purposes.

### BACKGROUND

Aspects of the disclosure relate to computer software, computing devices, and computing technology. In particular, some aspects of the disclosure relate to computer software, computing devices, and computing technology for image-based product mapping.

As mobile devices, such as smart phones, tablet computers, and other mobile computing devices become increasingly popular, there may be more and more opportunities for retailers and other merchants to leverage the capabilities of such devices in providing customers with enhanced shopping experiences. Given the information-driven nature of such devices, however, a retailer or other merchant might need to expend a great deal of resources in gathering, organizing, and maintaining the information needed to support such experience-enhancing applications. In addition, the efforts of some retailers and merchants may be redundant with those of others, and consumers wishing to use such applications might need to download and/or otherwise obtain a number of different, retailer-specific applications and select a particular application each time they visit a different merchant.

Various embodiments of the invention address these and other issues, individually and collectively.

### SUMMARY

Certain embodiments are described that enable and provide image-based product mapping.

Some embodiments relate to receiving images captured at various locations and analyzing such images to identify one or more products available and/or otherwise positioned at such locations. For example, in some embodiments, a server computer may receive a plurality of images from a number of different devices, as well as information specifying the locations at which such images were captured. Subsequently, the server computer may analyze the images to identify the products included therein. Then, the server computer may store, in at least one database, information associating each identified product with the location at which the image including the identified product was captured. In at least one arrangement, the server computer then may generate, based on the information in the at least one database, mapping data describing the locations of the various products.

Other embodiments relate to capturing an image of a product at a particular location and providing the image to a server computer for further analysis. For example, in some embodiments, a mobile computing device may capture an image of a product at a particular location, and then may provide the image and information identifying the particular location to a server computer for analysis and product identification. In some additional arrangements, the mobile computing device also may receive mapping data from the server computer, display maps based on the mapping data, and provide navigation instructions to places where other products are located. Additionally or alternatively, the mobile computing device may provide a user with an incentive to capture an image of a particular product or to visit a particular location, and/or may provide a payment interface enabling one or more products to be purchased.

These and other embodiments are described in further detail below.

### BRIEF DESCRIPTION OF THE DRAWINGS

FIG. 1 illustrates a simplified diagram of a system that may incorporate one or more embodiments of the invention;

FIG. 2 illustrates a simplified diagram of a system that may incorporate one or more additional and/or alternative embodiments of the invention;

FIG. 3 illustrates an example operating environment for various systems according to one or more illustrative aspects of the disclosure;

FIG. 4 illustrates an example of a captured product data message according to one or more illustrative aspects of the disclosure;

FIG. 5 illustrates an example method of image-based product mapping according to one or more illustrative aspects of the disclosure;

FIG. 6 illustrates an example method of capturing product data according to one or more illustrative aspects of the disclosure;

FIG. 7 illustrates an example of a computing device that may implement one or more aspects of the disclosure;

FIG. 8 illustrates an example of a location at which product information may be captured according to one or more illustrative aspects of the disclosure;

FIG. 9 illustrates an example of a system that may be used in image-based product mapping according to one or more illustrative aspects of the disclosure;

FIG. 10 illustrates an example method of generating mapping information according to one or more illustrative aspects of the disclosure;

FIG. 11 illustrates an example of a central server computer that may be used in image-based product mapping according to one or more illustrative aspects of the disclosure;

FIG. 12 illustrates an example method of providing an item image to a central server computer according to one or more illustrative aspects of the disclosure;

FIG. 13 illustrates an example method of locating a mapped item with a mobile device according to one or more illustrative aspects of the disclosure;

FIGS. 14-18 illustrate example user interfaces of a mapping application according to one or more illustrative aspects of the disclosure; and

FIG. 19 illustrates an example of a mobile device according to one or more illustrative aspects of the disclosure.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Certain embodiments are described that relate to using images of products captured at particular locations to generate, store, provide, and/or use mapping data that describes the locations of such products. Some embodiments may enable a computing device, such as a mobile device, and/or a user thereof, to determine the location of a particular product, which may include not only the location of a particular store at which the product is located, but also the specific location of the product within the store.

While some conventional systems may provide other types of item mapping and/or other types of location mapping, these systems typically require a great deal of manual user input to obtain and maintain mapping information. For example, to populate mapping information in such systems, one or more administrative users may need to manually input information specifying the location(s) of various item(s) and/or other features. In addition, these conventional systems may provide mapping information that is relevant only to locations owned and/or operated by a specific, single entity, such as the entity that undertook the mapping effort in the first place. Thus, users of conventional systems and applications might find such systems and applications to be limited, as mapping information might exist for certain locations, but not others. Further still, a user might be forced to have a number of different applications downloaded to and/or otherwise available on their mobile device for use with viewing maps and/or locating items at different merchant locations.

Various embodiments of the invention, as further described below, have a number of advantages. For example, by analyzing images that are captured at a number of different merchant locations to identify the products that may be included in the images, data in a product information database may be more easily gathered and updated, and the amount of resources typically required for conventional types of item mapping may be greatly reduced. In addition, because aspects of the disclosure provide systems and applications that map different products provided by different merchants at a number of different locations (rather than being limited to use with a single merchant and/or a single location), greater convenience is provided to users of such systems and applications. In particular, not only may a consumer use a single application or system to obtain and/or use product mapping information at a number of different merchant locations associated with a number of different merchants, but the merchants themselves may be able to reduce, if not eliminate, the amount of resources that might otherwise be expended in item-mapping efforts. In addition, by using and analyzing images captured at various merchant locations to perform product mapping, the amount of resources that might otherwise be expended in manually mapping items at various locations associated with different entities, such as may be required by conventional item-mapping systems, can be reduced.

Embodiments implementing these and other features, including various combinations of the features described herein, may provide the advantages discussed above and/or other additional advantages.

Prior to discussing various embodiments and arrangements in greater detail, several terms will be described to provide a better understanding of this disclosure.

As used herein, a “merchant location” may refer to store, market, outlet, or other location at which goods are sold and/or services are provided by a manufacturer, merchant, or other entity. Large merchants, such as chain stores, may have a number of individual merchant locations at geographically distinct locations, such as in different states, cities, towns, villages, and/or the like. Typically, an individual merchant location may correspond to a single street address, such that two stores located on opposite sides of the same street (and thus having different street addresses) may be considered to be two different merchant locations, even if the two stores are owned and/or operated by the same commercial entity.

A “product” as used herein may refer to a good or other item that is sold, available for sale, displayed, stocked, and/or otherwise positioned at a merchant location.

A “mobile device” as used herein may refer to any device that is capable of being transported to a merchant location and/or capable of being moved to different positions within the merchant location. As discussed below, a mobile device may include a computing device, and further may be used to capture images of products at one or more merchant locations. Examples of mobile devices include smart phones, tablet computer, laptop computers, personal digital assistants, and/or other mobile computing devices.

A “server computer” as used herein may refer to a single computer system and/or a powerful cluster of computers and/or computing devices that perform and/or otherwise provide coordinated processing functionalities. For example, a server computer can be a large mainframe, a minicomputer cluster, or a group of servers functioning as a unit. In one example, the server computer may be a database server coupled to an Internet server and/or a web server.

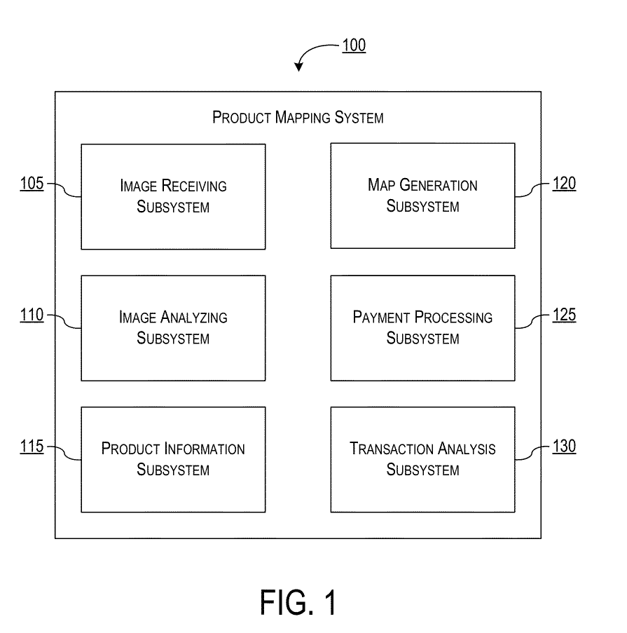

Various embodiments will now be discussed in greater detail with reference to the accompanying figures, beginning with FIG. 1.

FIG. 1 illustrates a simplified diagram of a product mapping system 100 that may incorporate one or more embodiments of the invention. In the embodiment illustrated in FIG. 1, system 100 includes multiple subsystems, including an image receiving subsystem 105, an image analyzing subsystem 110, a product information subsystem 115, a map generation subsystem 120, a payment processing subsystem 125, and a transaction analysis subsystem 130. One or more communications paths may be provided that enable the one or more subsystems to communicate with each other and exchange data with each other. In addition, the various subsystems illustrated in FIG. 1 may be implemented in software, hardware, or combinations thereof. In some embodiments, system 100 may be incorporated into a server computer, such as a server computer that is configured to perform and/or otherwise provide product-mapping functionalities.

In various embodiments, system 100 may include other subsystems than those shown in FIG. 1. Additionally, the embodiment shown in FIG. 1 is only one example of a system that may incorporate some embodiments, and in other embodiments, system 100 may have more or fewer subsystems than those illustrated in FIG. 1, may combine two or more subsystems, or may have a different configuration or arrangement of subsystems.

In some embodiments, image receiving subsystem 105 may allow for system 100 to receive images, and in some instances, the received images may include one or more products. For example, image receiving subsystem 105 may include one or more communication interfaces, such as one or more wired and/or wireless network interfaces, that enable system 100 to receive images from and/or otherwise communicate with one or more image-capturing devices and/or other computing devices. The images may be received by image receiving subsystem 105 of system 100 from a number of different image-capturing devices. For example, image receiving subsystem 105 may receive images by communicating with one or more mobile devices, such as one or more smart phones, tablet computers, and/or other user devices or mobile devices used by customers and/or other entities at various locations, including one or more stores and/or other merchant locations. In addition, image receiving subsystem 105 may receive images by communicating with one or more surveillance cameras positioned at various locations, such as one or more stores and/or other merchant locations; one or more robotic devices which may be configured to patrol, capture, and/or provide images from various locations, including one or more stores and/or other merchant locations; and/or one or more other image-capturing devices, such as devices configured to be worn on or as an article of clothing (e.g., a specialized hat or t-shirt that includes a camera and/or other circuitry that enables images and location information to be captured and provided to image receiving subsystem 105).

In addition to receiving image data from one or more image-capturing devices, image receiving subsystem 105 also may receive location information from the image-capturing devices, and the location information may describe the particular location(s) at which the received image(s) were captured. The location information may include geographic coordinates, such as latitude, longitude, and altitude, and/or other information indicative of position. As described in greater detail below, the location information may be used by system 100 to associate the images received from the image-capturing devices by image receiving subsystem 105, and/or information about the particular products included therein, with the particular locations at which such images were captured by the image-capturing devices. This may enable system 100 to generate and/or update mapping data that describes where such products are located and/or available for purchase.

In some embodiments, image analyzing subsystem 110 may allow for system 100 to analyze one or more images received by image receiving subsystem 105 and/or identify one or more products included in such images. For example, image analyzing subsystem 110 may include one or more image analysis devices and/or image analysis modules that may be configured to process the images received from image receiving subsystem 105 and use pattern-matching and/or other object-recognition techniques to identify the one or more products, and/or one or more other objects, that may be included in each of the received images. In some arrangements, image analyzing subsystem 110 may use information obtained from product information subsystem 115 that defines identifying characteristics of various products. In other arrangements, image analyzing subsystem 110 may store and/or otherwise access information about various products in order to identify products included in the images received by image receiving subsystem 105.

In some embodiments, product information subsystem 115 may allow system 100 to store information about various products. This information may include both identifying characteristics of various products and/or previously-analyzed image-capture data. As discussed above, the information about the identifying characteristics of various products may be used, for instance, by image analyzing subsystem 110 in processing received images to identify the products included in such images. The previously-analyzed image-capture data may, on the other hand, include one or more images, information specifying one or more identified products included in such images, and/or location information specifying the one or more particular locations at which such images were captured.

For example, in one or more arrangements, product information subsystem 115 may store, host, and/or otherwise access a database in which information about various products may be stored. In some embodiments, the information stored in the database provided by product information subsystem 115 may define associations and/or other relationships between particular products and the locations at which such products may be found. As noted above, these locations may be both the particular stores and/or other outlets at which such products can be purchased, as well as the specific locations within such stores and/or outlets at which such products can be found, such as the particular aisle(s), shelf(s), counter(s), rack(s), etc. within a particular store where the product may be found. In addition, the information stored by product information subsystem 115 may enable system 100 to generate product mapping data, as discussed in greater detail below.

In one or more arrangements, the database provided by product information subsystem 115 may include and/or otherwise represent crowd-sourced product information. For example, the information included in the database provided by product information subsystem 115 may be collected from a number of different devices operated by a number of different users and/or other entities, and thus may be considered to be “crowd-sourced.” As an example, some information in the database provided by product information subsystem 115 may originate from images captured by individual consumers at various merchant locations. On the other hand, other information included in the database may originate from images captured by employees of and/or contractors associated with the various merchants, who may, for instance, be tasked with capturing such images at these merchant locations. In some instances, specialized image-capture devices, such as devices configured to be worn on or as an article of clothing, may be used by such employees and/or contractors to capture images for image-based product mapping. Additionally or alternatively, other sources may provide images from different merchant locations that may be used in populating the database provided by product information subsystem 115. For example, robotic devices (e.g., flying robotic helicopters, ground-based robots, etc.) may be deployed at various merchant locations, and such robotic devices may be configured to patrol and/or explore such locations, capture images, and provide the captured images back to system 100 for analysis and product mapping.

In some embodiments, map generation subsystem 120 may allow system 100 to generate mapping data about various products and/or various locations. For instance, for a particular product, such mapping data may specify a rough location at which the product may be found (e.g., the geographic coordinates of a store or market where the product is available) and/or a specific location at which the product may be found (e.g., the coordinates/location within the particular store or market where the product is available). In one or more arrangements, the mapping data generated by map generation subsystem 120 may define the location of a first product (e.g., laundry detergent) in relation to one or more other products (e.g., paper towels, glass cleaner, etc.) that are available at the same location (e.g., within the same store, within the same section or department of a particular store, etc.). In addition, the mapping data generated by map generation subsystem 120 may, in some instances, represent an actual map of a location at which one or more products are available. Such a map may, for instance, define and/or otherwise include a graphical representation of the location (e.g., a store, a particular section or department of a store, etc.) and the particular positions of one or more products located therein (e.g., the particular aisle(s), shelf(s), rack(s), etc. at which the one or more products are available). As discussed in greater detail below, the mapping data generated by map generation subsystem 120 of system 100 may be used in navigating a user to a place where a particular product is located and/or in otherwise providing navigation instructions to a user, which may include displaying a user interface that includes a graphical map of the user's location, the location(s) of one or more products for which the user may have searched, and/or the route(s) from the user's location to the location(s) of the one or more products. Additionally or alternatively, map generation subsystem 120 may communicate with product information subsystem 115 in order to generate such a map based on the information stored in the database(s) provided by product information subsystem 115.

In some embodiments, payment processing subsystem 125 may allow system 100 to authorize and/or otherwise process payment transactions. For example, payment processing subsystem 125 may include one or more communication interfaces, such as one or more wired and/or wireless networking interfaces, that enable system 100 to communicate with one or more payment servers and/or payment networks. Via such communication interfaces, payment processing subsystem 125 may read data from, write data to, and/or otherwise access one or more payment networks, payment applications, and/or payment databases, such as one or more account databases, which may include data used in authorizing and/or otherwise processing transactions, such as account numbers, account passwords, account balances, and the like.

In some embodiments, transaction analysis subsystem 130 may allow system 100 to analyze one or more transactions and/or determine one or more products purchased in such transactions. For example, transaction analysis subsystem 130 may receive data from and/or otherwise communicate with payment processing subsystem 125 to receive payment information associated with a transaction completed at a particular location. The payment information may, for instance, include a transaction amount, information identifying the payor in the transaction, and/or information identifying the payee in the transaction. Subsequently, transaction analysis subsystem 130 may load data from and/or otherwise communicate with product information subsystem 115 to load information about various products, including pricing data, location data, and/or other information associated with particular products. Thereafter, transaction analysis subsystem 130 may determine, based on the location where the transaction was completed (e.g., as provided by payment processing subsystem 125), the amount of the transaction, and/or the information received from product information subsystem 115, which particular product or products were purchased by the payor in the transaction.

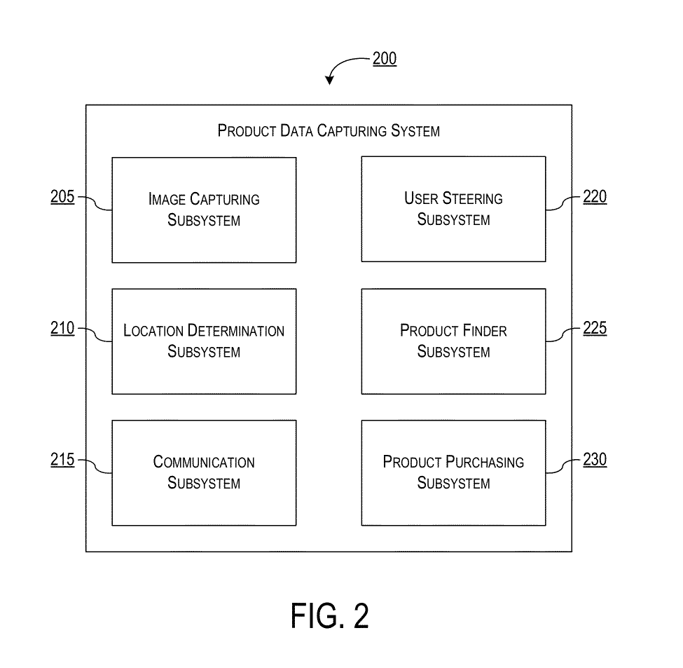

Having described various aspects of a system that can be used in mapping a number of products and/or locations, a system that may be used in capturing product data will now be described in greater detail with respect to FIG. 2.

FIG. 2 illustrates a simplified diagram of a product data capturing system 200 that may incorporate one or more additional and/or alternative embodiments of the invention. In the embodiment illustrated in FIG. 2, system 200 includes multiple subsystems, including an image capturing subsystem 205, a location determination subsystem 210, a communication subsystem 215, a user steering subsystem 220, a product finder subsystem 225, and a product purchasing subsystem 230. One or more communications paths may be provided that enable the one or more subsystems to communicate with and exchange data with each other. In addition, the various subsystems illustrated in FIG. 2 may be implemented in software, hardware, or combinations thereof. In some embodiments, system 200 may be incorporated into a mobile device, such as a smart phone, tablet computer, or other mobile computing device, that is configured to perform and/or otherwise provide image-capturing functionalities.

In various embodiments, system 200 may include other subsystems than those shown in FIG. 2. Additionally, the embodiment shown in FIG. 2 is only one example of a system that may incorporate some embodiments, and in other embodiments, system 200 may have more or fewer subsystems than those illustrated in FIG. 2, may combine two or more subsystems, or may have a different configuration or arrangement of subsystems.

In some embodiments, image capturing subsystem 205 may allow for system 200 to capture one or more images. In some instances, the captured images may be captured at a particular location, which may be determined by location determination subsystem 210 of system 200, as further discussed below, and may include one or more products. For example, image capturing subsystem 205 may include one or more cameras and/or other hardware components that are configured to capture and/or store image data.

In some arrangements, image capturing subsystem 205 may be configured to capture images automatically. For example, image capturing subsystem 205 may be configured to capture images based on a predetermined schedule (e.g., every sixty seconds, every five minutes, etc.), and/or based on a determination by system 200 that system 200 is located in a particular place (e.g., at a particular store and/or at a particular location within a store, such as a particular rack or counter), and/or based on other factors.

In some embodiments, location determination subsystem 210 may allow system 200 to determine its current location. In particular, location determination subsystem 210 may enable system 200 to determine its location as being at a particular store or at a particular merchant location, and/or may enable system 200 to determine its particular location within the store or merchant location. For example, location determination subsystem 210 may include one or more Global Positioning System (GPS) receivers, one or more accelerometers, one or more magnetometers, and/or one or more gyroscopes that enable system 200 to determination its position based on sensor data provided by these components and/or signals received by these components, such as received satellite signals. Location determination subsystem 210 may, for instance, use data received from one or more accelerometers, one or more magnetometers, and/or one or more magnetometers to track and/or otherwise determine the position of system 200 within a store or other merchant location. These tracking and position determination functionalities may, for instance, enable location determination subsystem 210 to determine or provide information to system 200 indicating that system 200 is positioned at a particular location within a merchant location, such as a particular rack, counter, aisle, and/or the like.

Additionally or alternatively, the position information determined by position determination subsystem 210 may allow system 200 to tag images captured by image capturing subsystem 205 with location data, thereby indicating the particular place at which such images were captured. In some embodiments, location determination subsystem 210 may be configured to determine a position fix for system 200 concurrently with and/or immediately after an image is captured by image capturing subsystem 205 of system 200. This configuration may, for instance, allow captured images to be more accurately tagged with corresponding location information.

In some embodiments, communication subsystem 215 may allow system 200 to communicate electronically with one or more other devices and/or systems. For example, communication subsystem 215 may include one or more wired and/or wireless communication interfaces that enable system 200 to communicate with one or more other computing devices, networks, and/or systems, such as system 100. Examples of wired communication interfaces that may be included in communication subsystem 215 include one or more Ethernet interfaces, one or more Universal Serial Bus (USB) interfaces, and/or the like. In addition, examples of wireless communication interfaces that may be included in communication subsystem 215 include one or more Bluetooth interfaces, one or more IEEE 802.11 interfaces (e.g., one or more IEEE 802.11a/b/g/n interfaces), one or more ZigBee interfaces, and/or the like.

In one or more arrangements, communication subsystem 215 may enable system 200 to provide image data (such as image data captured by image capturing subsystem 205) and location data associated with the image data (such as location data determined by location determination subsystem 210) to a server computer. For example, in some arrangements, communications subsystem 215 may enable system 200 to establish a connection with system 100 and subsequently provide such image and/or location data to system 100.

In some embodiments, user steering subsystem 220 may allow system 200 to provide incentives to a user of the system. Such incentives may include, for instance, incentives that are configured to cause a user to capture an image of a particular product, capture an image of a particular location, purchase a particular product, and/or visit a particular location. Thus, some incentives may “steer” a user from one location to another. In some arrangements, user steering subsystem 220 may store a database of available incentives, and the incentives included in the database may be updated, modified, and/or deleted by one or more merchants and/or manufacturers. In addition, user steering subsystem 220 may be configured to provide a user with incentives from the database based on the current location of system 200 (e.g., as determined by location determination subsystem 210), based on a predetermined schedule (e.g., the current time of day, the current day of the week, the current date, etc.), and/or based on external data (e.g., a command or request from a particular merchant or manufacturer that a particular incentive be displayed and/or otherwise provided). As discussed in greater detail below, examples of incentives that may be provided include coupons, free products, entries into raffles, and/or digital rewards, such as tokens, badges, and/or points that may be associated with completing a scavenger hunt, quest, or other gaming experience.

In some embodiments, product finder subsystem 225 may allow system 200 to inform a user of the location of a particular product. For example, product finder subsystem 225 may be configured to receive a query for a particular product or products from the user, and determine a location of the queried product(s) based on mapping data, which may, for instance, be obtained from system 100 using communication subsystem 215. In addition, product finder subsystem 225 may be further configured to provide navigation instructions from a current location (e.g., as determined by location determination subsystem 210) to the location of the product(s) that the user seeks.

In some embodiments, product purchasing subsystem 230 may allow system 200 to be used in completing a purchase of a particular product or products. For example, product purchasing subsystem 230 may provide a payment interface that allows a user to purchase a particular product. In some arrangements, the payment interface may be displayed or otherwise provided to the user in response to the user capturing an image of the product. This may enable a user to purchase products at a store or other merchant location by simply taking a picture of the products using system 200.

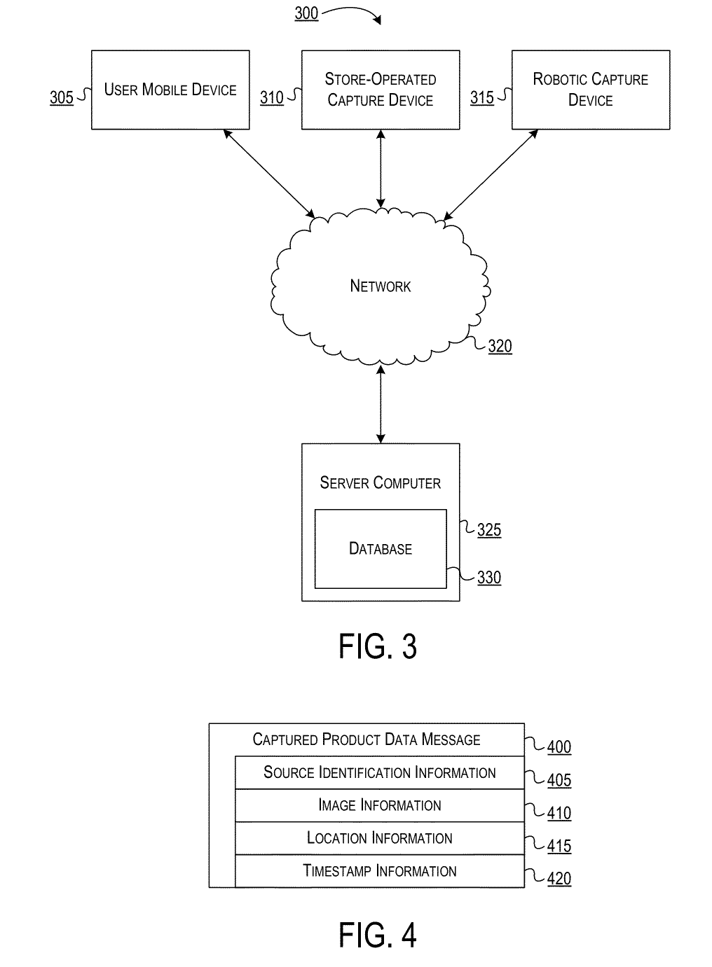

Having described various aspects of a system that can be used in capturing product data, an example operating environment for various systems discussed herein will now be described in greater detail with respect to FIG. 3.

FIG. 3 illustrates an example operating environment 300 for various systems according to one or more illustrative aspects of the disclosure. In particular, as seen in FIG. 3, operating environment 300 may include one or more product data capture devices and/or systems, such as a user mobile device 305, a store-operated capture device 310, and/or a robotic capture device 315. In one or more arrangements, the product data capture devices, which each may implement one or more aspects of system 200 (e.g., as described above with respect to FIG. 2), may communicate via a network 320 with a server computer 325 that stores a product information database 330. In at least one arrangement, server computer 325 may incorporate one or more aspects of system 100. For example, server computer 325 may receive images captured by one or more of user mobile device 305, store-operated capture device 310, and robotic capture device 315, and analyze such images in order to identify one or more products included therein.

In some embodiments, user mobile device 305 may be a personal smart phone, tablet computer, or other mobile computing device owned and/or operated by a consumer visiting a merchant location. Store-operated capture device 310 may, for instance, be an image capture device that is owned by a store or merchant and operated by an employee or contractor of the store or merchant. For example, such a store or merchant may use store-operated capture device 310 to initially populate and/or update product mapping data associated with the particular store or merchant location. In addition, robotic capture device 315 may, for instance, be an automated capture device that is configured to patrol a particular store or merchant location (or a plurality of stores and/or merchant locations) in order to capture images and update product mapping information associated with the location or locations.

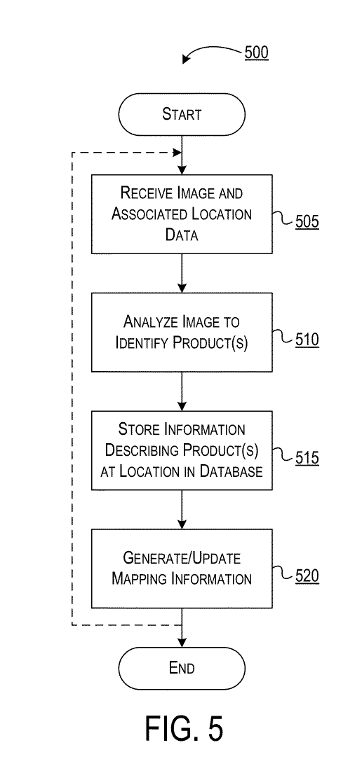

Having described an example operating environment for various systems discussed herein, an example of a data message that may be sent from an image capture device to a server computer will now be described in greater detail with respect to FIG. 4.

FIG. 4 illustrates an example of a captured product data message 400 according to one or more illustrative aspects of the disclosure. In some embodiments, captured product data message 400 may be sent as one or more data messages from an image capture device to a server computer in order to provide the server computer with one or more captured images and location information associated with such images. For example, an image capture device (e.g., user mobile device 305, store-operated capture device 310, and/or robotic capture device 315 shown in FIG. 3) may send captured product data message 400 to a server computer (e.g., server computer 325 shown in FIG. 3), as this may enable the server computer to analyze the captured image(s) to determine the position of particular products at various locations.

As seen in FIG. 4, captured product data message 400 may include one or more data fields in which various types of information may be stored. For example, captured product data message 400 may include a source identification information field 405, an image information field 410, a location information field 415, and/or a timestamp information field 420. While these fields are discussed here as examples, a captured product data message may, in other embodiments, include additional and/or alternative fields instead of and/or in addition to those listed above.

In some embodiments, source identification information field 405 may include one or more unique identifiers assigned to and/or otherwise associated with the image capture device sending captured product data message 400. These unique identifiers may, for instance, include a serial number of the device, a user name or account number assigned to a user of the device, a model number of the device, and/or other information that may be used to identify the source of captured product data message 400.

In some embodiments, image information field 410 may include image data captured by the image capture device sending captured product data message 400. For example, image information field 410 may include digital graphic data (e.g., bitmap data, JPEG data, PNG data, etc.) that defines and/or otherwise corresponds to an image that is the subject of the captured product data message. In some additional and/or alternative arrangements, image information field 410 may contain a number of images captured by the image capture device at one particular location.

In some embodiments, location information field 415 may include information specifying the location at which the image or images included in image information field 410 were captured. For example, location information field 415 may include geographic coordinates (e.g., latitude, longitude, altitude, etc.) specifying where the image or images were captured. Additionally or alternatively, location information field 415 may include information specifying a particular position within a merchant location, such as a particular rack, counter, aisle, and/or the like, at which the image(s) were captured. Such information may, for instance, be expressed in coordinates that are defined relative to a particular point at the merchant location (e.g., a corner of the premises of the merchant location, a main entrance to the premises, a centroid of the premises, etc.).

In some embodiments, timestamp information field 420 may indicate the particular time at which the image or images (e.g., included in image information field 410 of the captured product data message) were captured by the device sending the captured product data message. The time information included in timestamp information field 420 may, for instance, allow a server computer that receives captured product data message 400 to determine whether and/or ensure that the product data included in a product information database hosted, maintained, and/or otherwise accessed by the server computer is up-to-date and/or otherwise sufficiently recent.

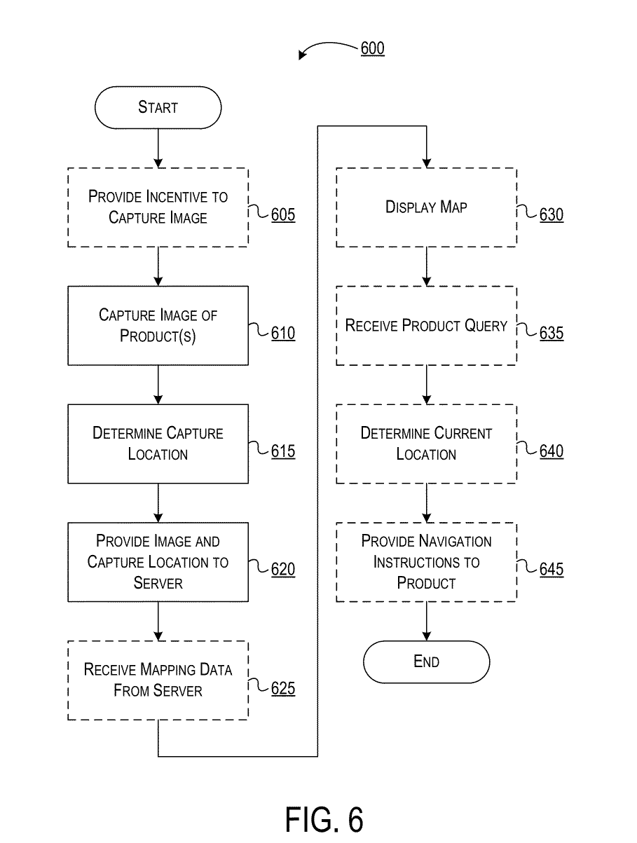

Having described an example of a data message that may be sent from an image capture device to a server computer, an example of a method that may be performed by such a server computer will now be described in greater detail with respect to FIG. 5.

FIG. 5 illustrates an example method 500 of image-based product mapping according to one or more illustrative aspects of the disclosure. The processing illustrated in FIG. 5 may be implemented in software (e.g., computer-readable instructions, code, programs, etc.) that can be executed by one or more processors and/or other hardware components. Additionally or alternatively, the software may be stored on a non-transitory computer-readable storage medium.

As seen in FIG. 5, method 500 may be initiated in step 505 in which an image and location data associated with the image may be received. In some embodiments, the image and the location data associated with the image may be received by system 100 of FIG. 1 and/or image receiving subsystem 105 thereof, for example, which may be incorporated into a server computer, such as a central server computer operated by a payment processor or other merchant services provider. In at least one arrangement, receiving an image and location data associated with the image may include receiving a captured product data message (e.g., captured product data message 400 shown in FIG. 4).

Subsequently, in step 510, the received image may be analyzed to identify one or more products included therein. For example, in step 510, the server computer (e.g., system 100 and/or image analyzing subsystem 110 thereof) may analyze the image received in step 505 using one or more pattern-matching techniques and/or other image analysis techniques to identify the one or more products that may be included in the image. In at least one arrangement, analyzing the image to identify the one or more products included therein may be based on product information stored in a database (e.g., product information stored by product information subsystem 115 of system 100), and such product information may specify identifying characteristics of various products.

Thereafter, in step 515, information describing the one or more identified products may be stored, in a product information database, in association with the particular location at which the image was captured. For example, in step 515, the server computer (e.g., system 100 and/or product information subsystem 115 thereof) may store information indicating that the identified product(s) may be found at the location at which the image was captured. As discussed above, this location may identify both the particular store or merchant location at which the product may be found, as well as the particular location within the store or merchant location at which the product is available, such as the particular aisle(s), shelf(s), counter(s), rack(s), and/or the like within the store where the product is displayed.

In step 520, mapping information may be generated and/or updated based on the information stored in the product information database. For example, in step 520, the server computer (e.g., system 100 and/or map generation subsystem 120 thereof) may generate mapping information for the location at which the image was captured (and/or other locations in the proximity of the location at which the image was captured) based on the information stored in the product information database. In at least one arrangement, such mapping information may define a graphical representation of the location and the particular position(s) of the one or more products located therein, as discussed above.

Subsequently, method 500 may continue to be executed (e.g., by the server computer, which may implement one or more aspects of system 100) in a loop, and additional images may be received and analyzed, and the results of such analysis may be stored in a product information database, as described above.

In some additional and/or alternative embodiments, different images can be received from different stores and/or merchant locations, and data can be stored in the same central product information database. For example, in some embodiments, the server computer (e.g., system 100) may receive captured product data messages, such as captured product data message 400 illustrated in FIG. 4, from devices located at different stores and/or merchant locations. After analyzing the information included in the various captured product data messages, the server computer (e.g., system 100) may store all of such analyzed information and/or received images in a single, central product information database. Advantageously, this centralized configuration may allow data from the product information database to be more easily accessed and/or more efficiently used by various systems and devices.

In some additional and/or alternative embodiments, a batch of images may be received and processed. For example, in some embodiments, the server computer (e.g., system 100) may receive a number of images simultaneously or substantially concurrently, and may analyze and process the images in the manner described above. Advantageously, this batch processing may allow the server computer to generate and/or update a large amount of product mapping data, as well as other information that may be stored in the product information database, in a more efficient manner.

In some additional and/or alternative embodiments, image data may be received from different devices and/or different users. For example, in some embodiments, the server computer (e.g., system 100) may receive captured product data messages (similar to captured product data message 400 shown in FIG. 4) from a number of different devices and/or a number of different users, and subsequently may analyze such images and store product information in the manner described above. Advantageously, by crowd-sourcing input image information in this manner, the server computer (e.g., system 100) may be able to receive a greater amount of image data for analysis, on a fairly regular basis and/or at a high frequency, which may allow the server computer (e.g., system 100) to generate and/or provide more complete and up-to-date product information.

In some additional and/or alternative embodiments, the server computer (e.g., system 100) also may be configured to receive payment information and analyze transactions to determine and store information about particular purchases by particular users. Such information may, for instance, be similarly stored in the product information database. Advantageously, the transaction and/or purchase information stored by the server computer (e.g., system 100 and/or payment processing subsystem 125 and transaction analysis subsystem 130 thereof) in these arrangements may allow the server computer to establish a purchase history for particular users and/or particular types or groups of users, such as users who are of a similar age group, geographic area, income level, and/or other demographic(s). This information may assist merchants and/or merchant services providers, such as payment processors, in gaining a better understanding of various consumers, as well as in marketing and/or advertising particular goods and/or services to such consumers.

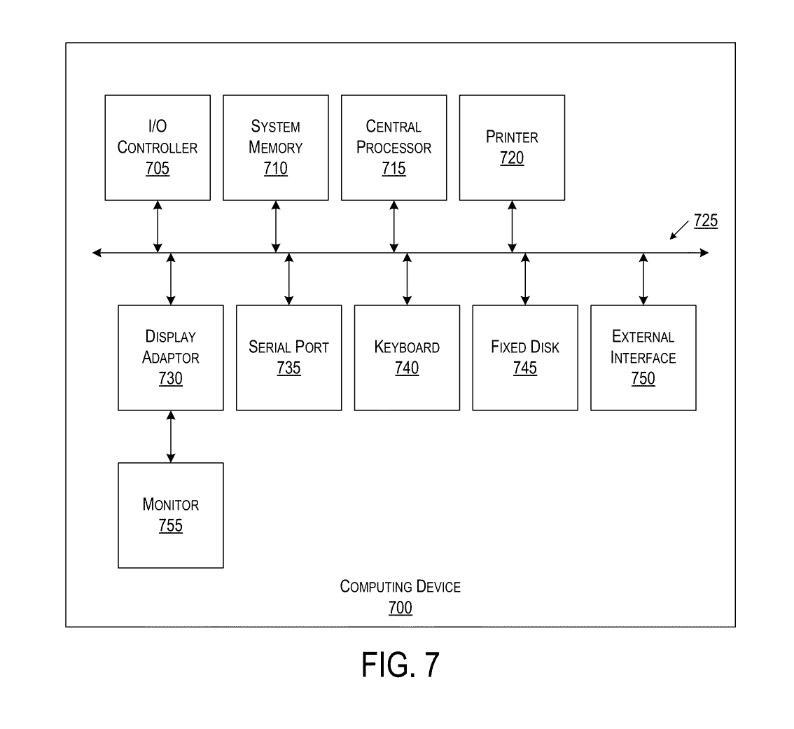

Having described an example of a product mapping method that may be performed by a server computer, an example of a method that may be performed by an image capture device will now be described in greater detail with respect to FIG. 6.

FIG. 6 illustrates an example method of capturing product data according to one or more illustrative aspects of the disclosure. The processing illustrated in FIG. 6 may be implemented in software (e.g., computer-readable instructions, code, programs, etc.) that can be executed by one or more processors and/or other hardware components. Additionally or alternatively, the software may be stored on a non-transitory computer-readable storage medium.

As seen in FIG. 6, method 600 may be initiated in step 605 in which an incentive to capture an image may be provided. In some embodiments, an incentive to capture an image may be provided by system 200 of FIG. 2 and/or user steering subsystem 220 thereof, for example, which may be incorporated into a mobile device, such as a mobile computing device operated by a consumer or other entity at a merchant location.

In one or more arrangements, providing an incentive to capture an image may include providing a coupon to a user of the mobile device conditioned on the user capturing one or more images of a particular product and/or capturing one or more images at a particular location. For example, in these arrangements, the mobile device (e.g., system 200 and/or user steering subsystem 220 thereof) may provide a coupon to a user of the device that is conditioned on the user capturing an image of a particular product (e.g., laundry detergent) within a store and/or conditioned on the user capturing an image at a particular location (e.g., at a particular aisle or on a particular shelf) within the store. While a coupon is used as an example of an incentive here, other rewards may similarly be offered to and/or provided to a user of a mobile device as incentives. For example, a free product, a raffle ticket, and/or digital rewards, such as points, badges, and/or other rewards associated with a scavenger hunt, quest, or other game may be offered to and/or provided to a user in exchange for the user capturing one or more particular images, as may be desired.

In step 610, an image may be captured, and the image may include one or more products. For example, in step 610, the mobile device (e.g., system 200 and/or image capturing subsystem 205 thereof) may capture an image at a particular position within a merchant location. In some instances, the captured image may include one or more products in accordance with various aspects of the disclosure.

In step 615, the location at which the image was captured may be determined. For example, in step 615, the mobile device (e.g., system 200 and/or location determination subsystem 210) may determine a current location of the mobile device, as this location may represent the location at which the image was captured. As described above, the location determined in step 615 may specify that the image was captured at a particular merchant location, and may further specify a particular position within the merchant location (e.g., a particular aisle, a particular counter, a particular rack, etc.) at which the image was captured. As also described above, the mobile device may determine its current location based on signals received by the mobile device (e.g., GPS signals) and/or based on sensor data captured by the mobile device (e.g., data provided by one or more accelerometers included in the mobile device, data provided by one or more magnetometers included in the mobile device, data provided by one or more gyroscopes included in the mobile device, etc.).

In step 620, the image, and the information specifying the position at which the image was captured, may be provided to a server computer. For example, in step 620, the mobile device (e.g., system 200 and/or communication subsystem 215) may provide the image captured in step 610 and information describing the location determined in step 615 to a server computer for analysis and product identification, as described above. In one or more arrangements, the server computer may implement one or more aspects of system 100, as discussed above with respect to FIG. 1, and/or may perform one or more steps of method 500, as discussed above with respect to FIG. 5, in order to analyze the image provided by the mobile device.

In step 625, mapping data may be received from the server computer. For example, in step 625, the mobile device (e.g., system 200) may receive mapping data from the server computer, and such mapping data may describe the positions of various products at the merchant location at which the mobile device (e.g., system 200) is currently located.

In step 630, a map of the current merchant location may be displayed. For example, in step 630, the mobile device (e.g., system 200) may display a map or other graphical representation of the merchant location at which the mobile device is located based on the mapping data received in step 625.

In step 635, a product query may be received. For example, in step 635, the mobile device (e.g., system 200 and/or product finder subsystem 225 thereof) may receive a query from a user of the mobile device for a particular product. In one or more arrangements, such a query may be received as user input provided by the user of the mobile device via one or more user interfaces. In response to receiving such a query, the mobile device (e.g., system 200) may determine, based on the mapping data received from the server computer, the location of the product(s) matching the query submitted by the user.

In step 640, a current location may be determined. For example, in step 640, the mobile device (e.g., system 200 and/or location determination subsystem 210) may determine the current location of the mobile device.

Subsequently, in step 645, navigation instructions may be provided from the current location to the location of the product(s) searched for by the user. For example, in step 645, the mobile device (e.g., system 200 and/or product finder subsystem 225) may provide navigation instructions and/or otherwise provide directions from a current location of the mobile device at the merchant location to the location of the product(s) that the user searched for in step 635. In some instances, the product that the user searched for may be available at the same merchant location at which the user and the mobile device are currently located. In these instances, the navigation instructions provided in step 645 may direct the user of the mobile device from one area of the current merchant location to another area of the current merchant location, such as another rack, aisle, counter, and/or the like. In other instances, the product searched for by the user in step 635 may be located at a different location than the merchant location at which the user and the mobile device are currently located. In these instances, the mobile device may provide navigation instructions from the current location of the mobile device to the location of the product(s) searched for by the user, even though such product(s) are located at a different merchant location.

In some additional and/or alternative embodiments, in response to capturing an image that includes a product, a coupon may be provided for the product included in the image. For example, in some embodiments, the mobile device (e.g., system 200) may provide a coupon for a product included in an image captured by the mobile device (e.g., in step 610). Such a coupon may, for instance, allow a user of the mobile device to obtain the product included in the image at a discount or for free. Advantageously, this may encourage a user of the mobile device to use a product mapping application to capture images of products, as not only may the user be rewarded with coupons, but such activity will correspondingly allow the server computer to receive and/or otherwise obtain up-to-date images of various merchant locations, which in turn may be used by the server computer in updating information stored in a product information database, as discussed above.

In some additional and/or alternative embodiments, in response to capturing an image that includes one or more products, a coupon may be provided for a product not included in the image. These features may enable the mobile device and/or a server computer in communication with the mobile device to steer the user of the mobile device from one location to another. For example, in response to capturing an image that includes one or more products at one area of a merchant location, the mobile device (e.g., system 200) may provide a coupon to the user of the mobile device for another product located in a different area of the merchant location, in order to steer the user from the current area of the merchant location to the different area of the merchant location where the other product is located. Advantageously, this may allow a merchant and/or a merchant services provider to control the flow of customers within the merchant location by steering such customers along different paths and/or to different areas within the merchant location.

In some additional and/or alternative embodiments, in response to capturing an image that includes one or more products, a payment interface may be provided to facilitate purchasing of the one or more products included the image. For example, in these embodiments, in response to capturing an image that includes one or more products (e.g., in step 610), the mobile device (e.g., system 200 and/or product purchasing subsystem 230) may display and/or otherwise provide one or more user interfaces that allow a user to purchase the one or more products included in the captured image. Advantageously, these features may allow the user of the mobile device to more easily purchase products at the merchant location, thereby increasing convenience for the user and increasing revenue for the merchant.

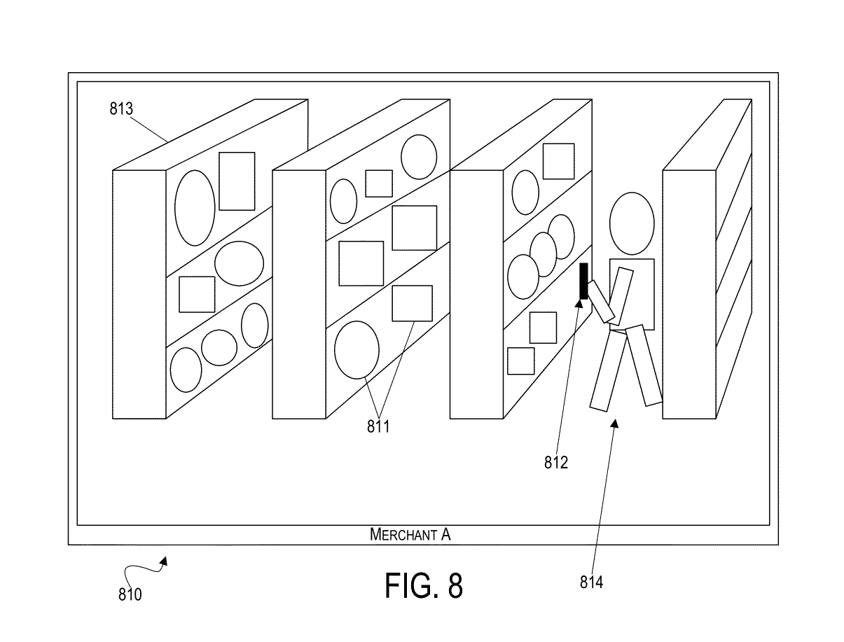

Having described an example of a method that may be performed by an image capture device, an example of a computing device that may implement various aspects of the disclosure will now be described with respect to FIG. 7.

FIG. 7 illustrates an example of a computing device 700 that may implement one or more aspects of the disclosure. The various systems, subsystems, devices, and other elements discussed above (including, without limitation, system 100 shown in FIG. 1, system 200 shown in FIG. 2, etc.) may use any suitable number of subsystems in the illustrated computing device 700 to facilitate the various functions described herein. Examples of such subsystems or components are shown in FIG. 7.

As seen in FIG. 7, the subsystems included in computing device 700 are interconnected via a system bus 725. Additional subsystems, such as a printer 720, a keyboard 740, a fixed disk 745 (or other memory computer computer-readable media), a monitor 755, which is coupled to a display adapter 730, and others, are shown. Peripherals and input/output (I/O) devices (not shown), which may be coupled to I/O controller 705, can be connected to the computer system by any number of means known in the art, such as via serial port 735. For example, serial port 735 or external interface 750 can be used to connect the computer apparatus to a wide area network, such as the Internet, a mouse input device, or a scanner. The interconnection via system bus 725 allows a central processor 715 to communicate with each subsystem and to control the execution of instructions from system memory 710 or fixed disk 745, as well as the exchange of information between subsystems. System memory 710 and/or fixed disk 745 may embody a computer-readable medium.

### Additional Embodiments

As discussed above, due to the emergence of technology, consumers are able to access an abundance of information about products before purchasing those products. Consumers can gain access through mobile devices, such as cellular telephones, smartphones and personal digital assistants (PDAs), which are commonly owned by consumers. These devices are often capable of communicating through both wireless and cellular networks in order to connect to the Internet or other informational databases. Often these devices can include applications to access specific information about a product, e.g., through a barcode or a receipt.

In many instances, consumers are able to not only view information relating to products, but purchase those products through e-commerce websites with no more than a few clicks of a button. Despite this availability, some consumers still wish to visit merchant locations and view a product before purchasing that product or purchase that product in person (e.g., groceries). However, the consumer may not wish to spend the time locating the product in a store, comparing prices at several stores, or finding the product in stock. In some instances, the consumer may already be within a larger store, such as a department store or a grocery store, and wish to locate a product while in that store.

As discussed above, various aspects of the disclosure provide methods and systems for mapping products through use of images taken of those products in a merchant location.

According to one or more aspects of the disclosure, product information within a store can be mapped and used by manufacturers, merchants, vendors, and consumers for various purposes. For a consumer, these maps can be utilized in order to quickly and easily locate a product while at a merchant location. For a manufacturer, product placement, pricing and sales can be observed and analyzed. Product mapping can be performed on the go (e.g., through consumers) and product mapping can be updated without manual entry to the system and on a continual basis.

In one embodiment, a method for mapping items in a location is provided. The method includes receiving one or more images of a geographical location at a central processing server, analyzing the one or more images to identify each item from a plurality of items, retrieving information for each item in the plurality of items, storing the information for each item on a database associated with the central processing server, and generating a map of the plurality of items in the geographical location. In some embodiments, the geographical location contains a plurality of items.

In another embodiment, a method for locating an item at a merchant location is provided. The method includes entering an item query on a mobile device and receiving location information for the item at the merchant location.

Various aspects of the disclosure provide methods and systems which facilitate consumer purchases and product inventory analysis through mapping items at a merchant location using photo and/or video images. In some embodiments, the images are captured by a user's mobile phone or other camera-enabled device. The images can be analyzed and stored on a central server database along with location information associated with each image. In this manner, items offered at the merchant location can be mapped.

Additionally or alternatively, when the products have been mapped in a merchant location, users can then use a mobile device to submit product location queries to the server and receive maps and/or directions to products at a merchant location. In alternative embodiments, the mapped product locations can be provided to the merchant or manufacturer.

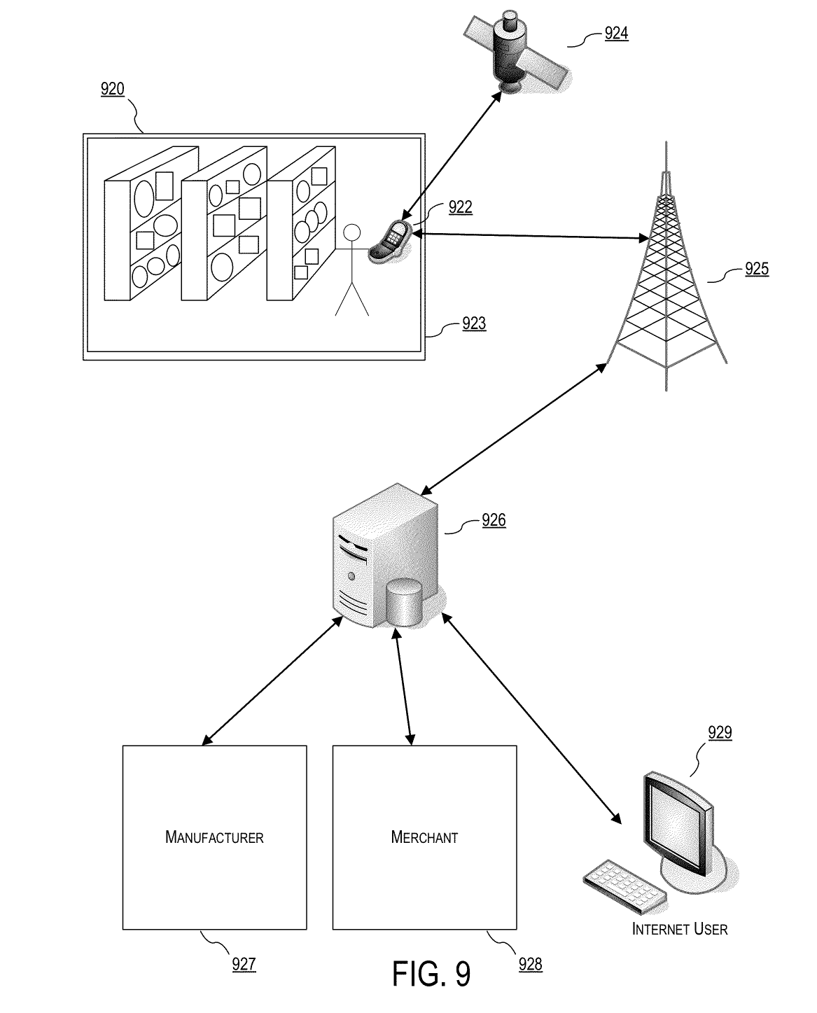

FIG. 8 illustrates a system in which a consumer 814 at a merchant location 810 is capable of capturing images of items 811 in that location using his mobile device. The merchant 810 can provide a plurality of products, e.g., items for sale 811, to a consumer 814 and have those items displayed/placed in a specific location. The consumer 814 can utilize a mobile device 812 in order to capture an image or multiple images, e.g., a video, a panoramic image, etc., of one or more of the items 811 at that merchant location. The items can be organized, for example, on shelves, aisles 813, or a specific area of the merchant location.

A mobile device 812 may be in any suitable form. For example, suitable mobile device 812 can be hand-held and compact so that they can fit into a consumer's purse/bag and/or pocket (e.g., pocket-sized). Some examples of mobile devices 812 include desktop or laptop computers, cellular phones, personal digital assistants (PDAs), and the like. In some embodiments, mobile device 812 is integrated with a camera and mobile device 812 embodied in the same device with the camera. Mobile device 812 then serves to capture images and/or video as well as communicate over a wireless or cellular network.

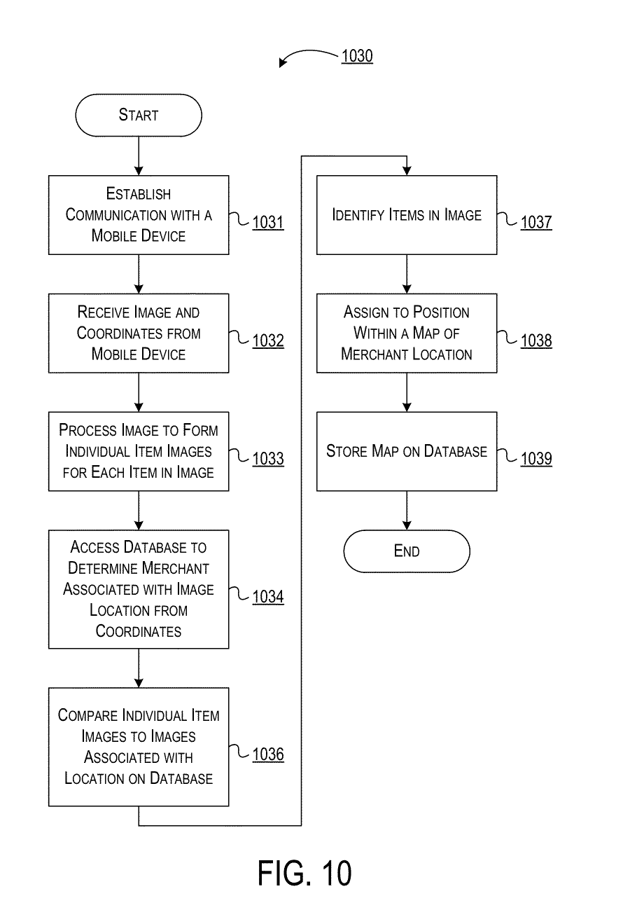

FIG. 9 illustrates an example communication system 920 for mapping items at a location. The system includes a consumer's mobile device 922, which is capable of capturing images of the items at a merchant location 923. The mobile device 922 is also in communication with a GPS satellite 924 or other location determining system, in order to provide location details to the central processing server to identify a merchant.

Mobile device 922 can communicate with a central processing server computer 926 through a wireless communication medium, such as a cellular communication 925 or through WiFi. In some embodiments, the captured images can be transmitted through a multimedia messaging service (MMS), electronic mail (e-mail) or any other form of communication to the central processing server 926 along with the current location information of the mobile device 922.

The central processing server 926 can then perform image processing on each of the received images to determine items depicted in each image, to identify a merchant from the location information, and to generate a map with that item at the merchant location. The central processing server can then communicate the map of and/or the directions to the mapped items at the merchant location 923 back to the consumer's mobile device 922, or to a manufacturer 927 of an item that has been identified and mapped at the merchant location 923. The central processing server 926 can also communicate the map to the merchant 928 whose items are mapped, e.g., once mapping is complete or when a predetermined number of items have been mapped. In other embodiments, the central processing server 926 can communicate the map to another user 929 having access to the network, e.g., through the Internet.

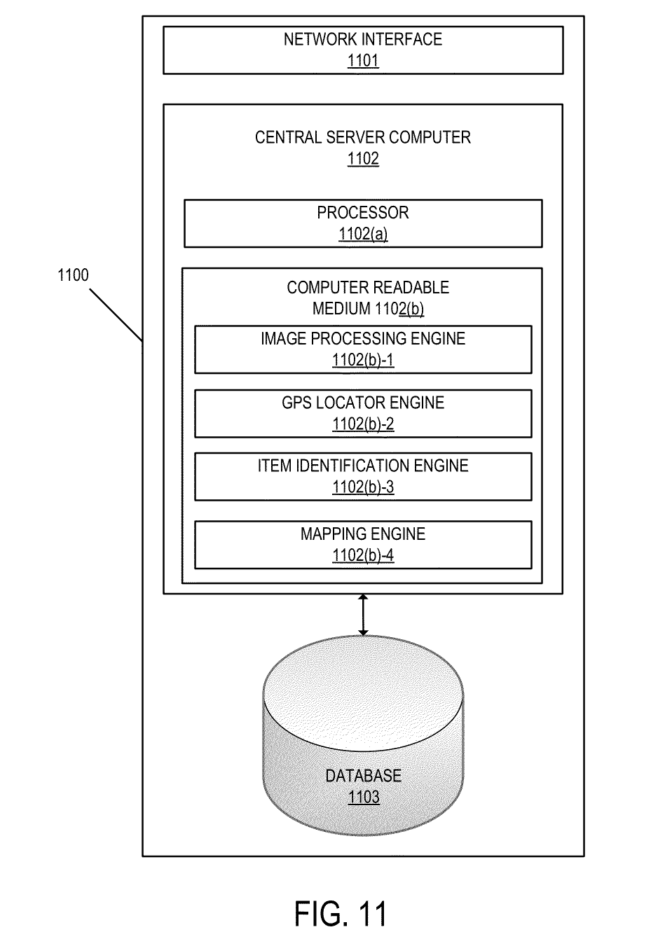

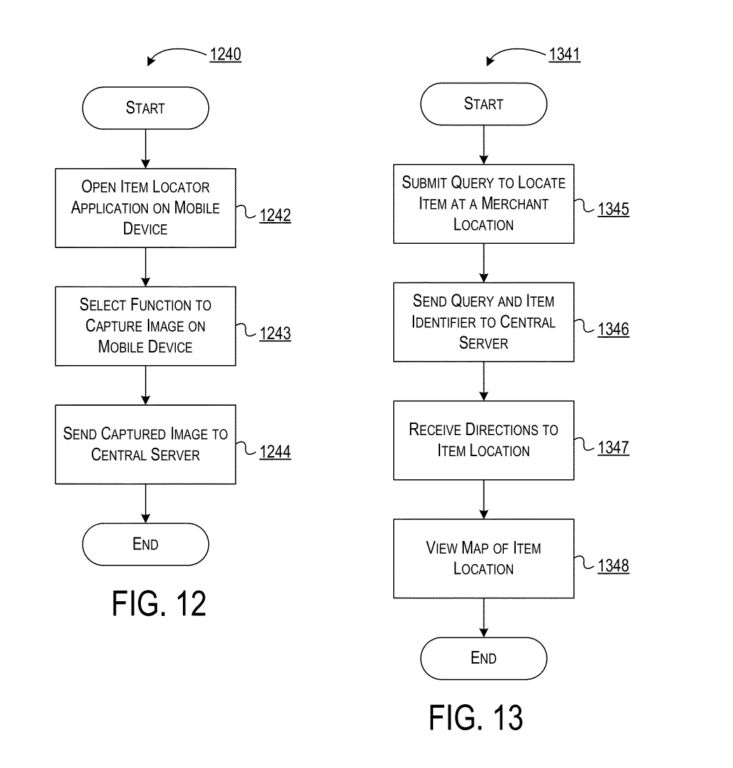

FIG. 10 provides an exemplary method 1030 for generating mapping information for items according to an embodiment of the present invention. The method 1030 can be performed, e.g., by the central processing server 926 of FIG. 9. FIG. 10 is described with reference to FIG. 11, which provides an exemplary central processing server computer capable of implementing method 1030 according to an embodiment of the present invention.

In step 1031, the central processing server 1100 establishes communication with a mobile device from which a captured image can be received. The central processing server 1100 includes a network interface 1101, which is capable of forming a communication channel with a network, e.g., Internet and/or a cellular network, such as through 4G, 3G, GSM, etc.

In step 1032, once the communication is established, the image data and the location data from the mobile device are received by the central processing server 1100. The central processing server 1100 can then process the image and the location information. The image can be in any suitable format, for example, .jpeg, .png, .tiff, .pdf, etc. In some embodiments, the images may be downloaded on a mobile device, e.g., through WiFi or near-field communication (NFC) link.

The central processing server 1100 can further include a central server computer 1102, which includes one or more storage devices, including a computer readable medium 1102(b), which is capable of storing instructions capable of being executed by a processor 1102(a). The instructions can be comprised in software which includes applications for processing the received images.

The storage devices can include a fixed disk or a system memory, disk drives, optical storage devices, solid-state storage devices such as a random access memory (“RAM”) and/or a read-only memory (“ROM”), which can be programmable, flash-updateable and/or the like. The computer-readable storage medium 1102(b), together (and, optionally, in combination with storage device(s)) comprehensively representing remote, local, fixed, and/or removable storage devices plus storage media for temporarily and/or more permanently containing, storing, transmitting, and retrieving computer-readable information. The network interface 1101 may permit data to be exchanged with the network and/or any other computer described above with respect to the system in FIG. 9.

The central processing server computer may also comprise software elements, including an operating system and/or other code, such as an application program (which may be a client application, Web browser, mid-tier application, RDBMS, etc.). It may be appreciated that alternate embodiments of a central processing server computer may have numerous variations from that described above. For example, customized hardware might also be used and/or particular elements might be implemented in hardware, software (including portable software, such as applets), or both. Further, connection to other computing devices such as network input/output devices may be employed.

In step 1033, the received image can be processed to identify each item depicted within the image. For example, an image may contain a plurality of items on a shelf. Each item in the received image can be separated from the image to generate individual item images and then further processed. The computer readable medium can include an image processing engine 1102(b)-1 which provides this item identification and separation on the newly received images.

In step 1034, the location information associated with the image data received from a mobile device can be utilized to determine the merchant location where the image was captured. As previously noted, this may include GPS coordinates or may be determined through cellular tower triangulation techniques, or other location determination systems. The merchant can be determined through location determination engine, e.g., GPS location engine 1102(b)-2, which can search the database 1103 coupled to the central server computer for a merchant associated with the location. In some embodiments, the location information for a merchant may not be stored within the database 1103, such as when a new merchant, map and/or images are being processed on the central processing server. In such embodiments, the locator engine 1102(b)-2, can establish a communication channel with the network through network interface 1101 to determine a merchant through the Internet. Once the merchant associated with the location information is determined, the merchant inventory list can also be accessed from the database 1103 and/or through the network, e.g., through a merchant website. The inventory list can be utilized to determine items in the merchant location through an image comparison. The item images associated with each item in the inventory list can be stored on the database 1103 and/or pulled from the network, e.g., through the Internet by performing a search with the item name.

In step 1036, the individual item images can be compared to the product images associated with the inventory list of the merchant to be identified. If the product images are not already stored on the database, the images can be determined through, e.g., the merchant website. An item identification engine 1102(b)-3 can be utilized to access the database 1103 and form connections with the network in order to identify each individual item.

In step 1037, a mapping engine 1102(b)-4 can generate a map of the merchant location based on item locations and/or access a basic outline map of the merchant location from the database 1103. The identified items can then be associated with the specified location in the merchant location where the image was captured and then assigned to that location in the map.

In step 1038, the map generated from the item images can be stored on the database 1103 and accessed each time a new image is received at the central processing server 1100 from that merchant location. Accordingly, some maps stored on the database 1103 may not be complete, e.g., may not include all item location information as not all the item images may have been received and processed yet. Additionally, the stored map can be updated as each new image is received from the merchant location. This helps to account for any new product placement at the merchant location.

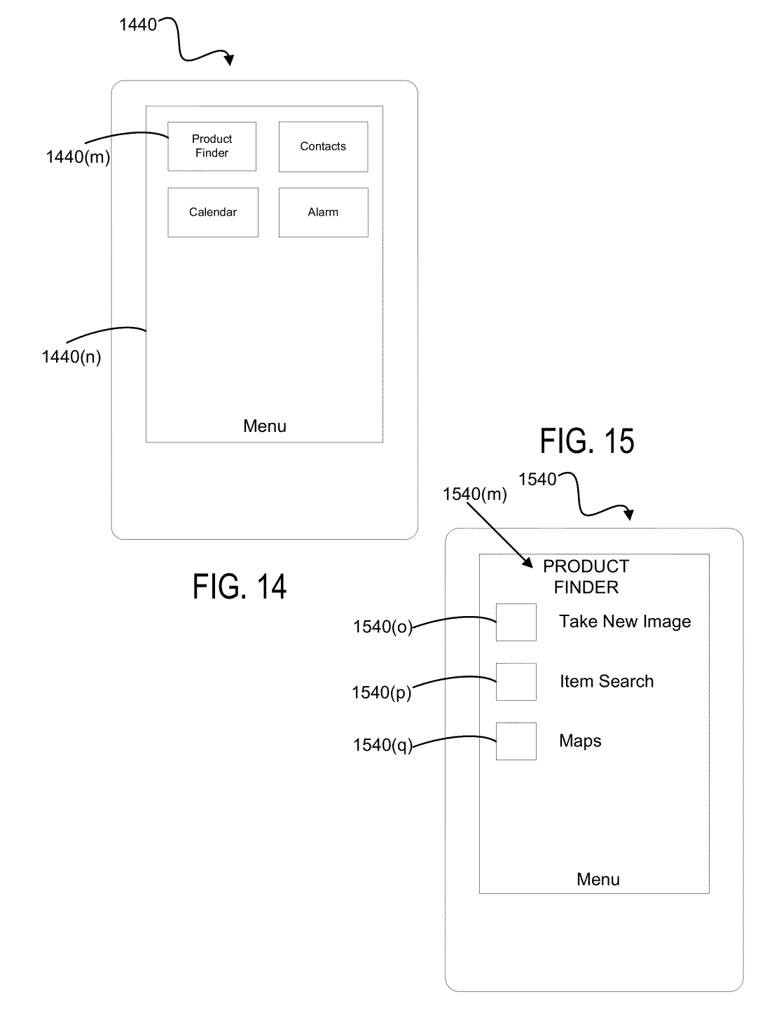

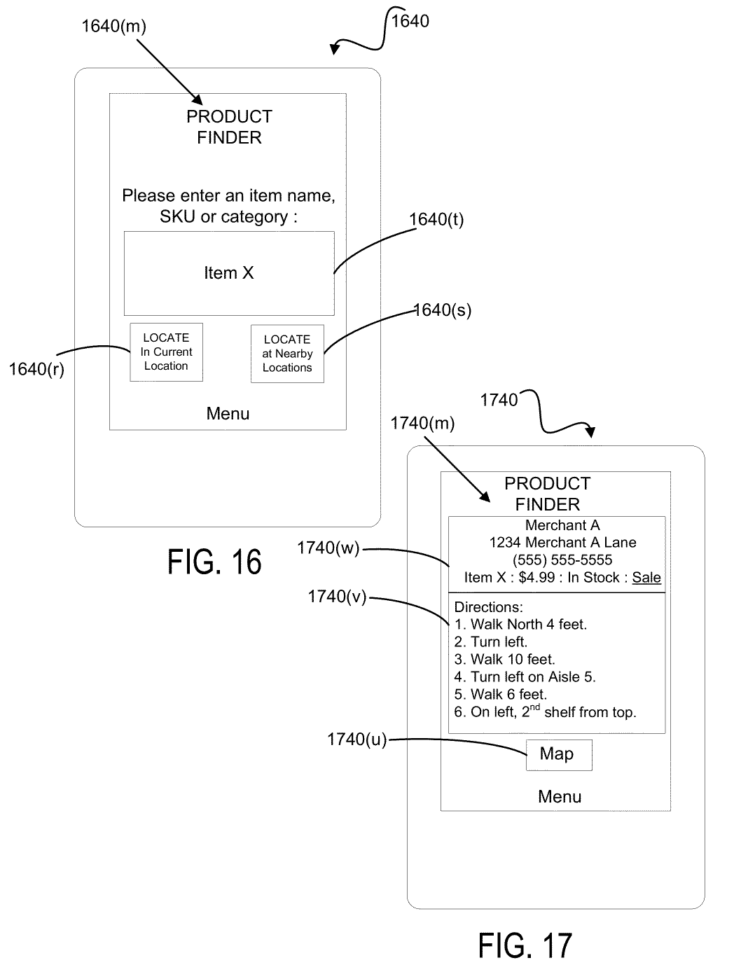

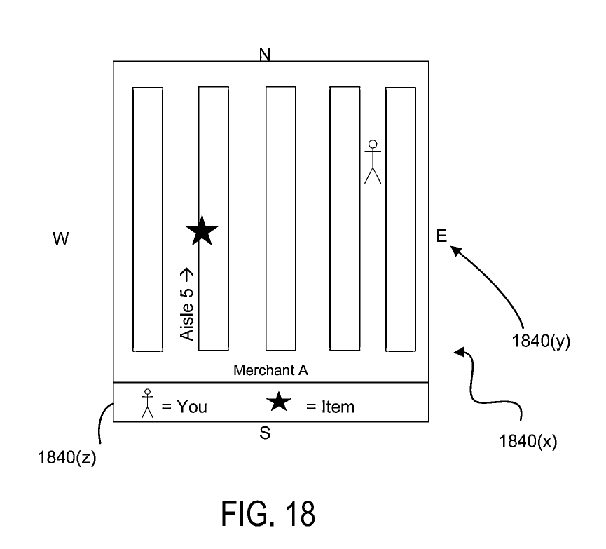

FIG. 12 provides a method 1240 for providing images for mapping items and FIG. 13 provides a method 1341 for accessing the maps to locate an item. Methods 1240 and 1341 are described within reference to FIGS. 14-18, which provide exemplary screenshots of a product finder application on a mobile device. In some embodiments, methods 1240 and 1341 can be performed, e.g., by mobile device 922 of FIG. 9.

Referring to FIG. 12, in step 1242, a user accesses an application 1440(m) stored on a mobile device 1440. As shown in FIG. 14, the application 1440(m) can be accessible to a user via a menu 1440(n) of the mobile device 1440.

In step 1243, after selecting the application 1440(m), the user selects which function to perform through the application 1540(m). For example, the user can capture a new image 1540(o), search for an item 1540(p) or view recent maps 1540(q). Any number of functions can be provided through the application 1540(m) and are not limited to the aforementioned functions.

In step 1244, an image is sent to the central server. In one embodiment, the user can select to “take a new image” 1540(o), which can provide the user with the camera function on camera-enabled devices to capture the image of the item. The user can also be provided with an option when selecting “take a new image” to search for and select an image on the Internet. In further embodiments, the user can also be provided with an option (e.g., through another function in the application) to access a stored image on the device 1540, such as an image received through an MMS text, downloaded an image from the Internet, or uploaded through a hardwired connection. When an image has be selected from the mobile device memory, selected on the Internet, or captured on a camera of the mobile device 1540, the image is then sent to the central processing server shown in FIG. 11 for processing, associating with a merchant location and storing on a database. Accordingly, the item can then be searched and mapped at a later time.

Referring now to FIG. 13, in step 1345, the user selects a function to search for an item, e.g., enter a query, through the application 1540(p) on the mobile device 1540 in one embodiment. For example, as shown in FIG. 15, this function can be accessed through the main page of the user interface in the application 1540(m). The user can enter an item identifier, such as an item name, a description, a type (e.g., kitchen, bathroom, food), etc. in a text field 1640(t) provided in the user interface, such as shown in FIG. 16. In a first embodiment, the user can select to look for an item at a current location 1640(r). For example, the user is shopping at a grocery store and wants to locate a specific item in that grocery store. In other embodiments, the user can select to locate the item at a nearby location 1640(s). The aforementioned embodiment may be useful, for example, in a situation where the user is not currently at a merchant location and/or if the user is currently at a merchant location but that merchant location does not have the item in stock.

Next, in step 1346, the user can submit the query, including the item identifier to the central server. The user can submit the query directly through the application, e.g., through a “send” button. In some embodiments, the query can be sent via a wireless communication medium, such as a cellular network, WiFi, or through a short range communication (e.g., near field communication). In some embodiments the query can be submitted via a wired communication medium.

In step 1347, the user can receive directions 1740(v) to the item submitted in the query in alphanumeric format on his mobile device, e.g., as provided in FIG. 17. For example, the user can view the directions in the user interface of the application on the mobile device 1740. In some embodiments, the user can receive a text message, email, or other communication with the directions.

In other embodiments, such as when the mapping of items in a particular merchant location is utilized by a manufacturer or a merchant, the alphanumeric format can be provided in terms of the item location in the merchant location. For example, the item can be indicated by name “Item X” and the location can be indicated as “Aisle 5, Left, Top Shelf” or a similar format. In such an embodiment, the manufacturer or merchant can then have a condensed listing of products/items at a merchant location to ensure the proper placement of those items.

In step 1348, the user can alternatively view a map of the item within the merchant location, e.g., as shown in FIG. 18. If the user is currently at that merchant location, the map can indicate the user's current position in relation to the requested item. In another embodiment, the map can provide a current position of the user in relation to the merchant location, and then provide a secondary map depicting the location of the item within the merchant location.

In an embodiment where the map is provided to a merchant and/or manufacturer, the map can be updated each time a new item is added and an alert can be sent to indicate that a new item has been added along with the location of that new item. In some embodiments, the manufacturer can be only provided with a map of the locations of products associated with that manufacturer. In other embodiments, a merchant can be notified of a new map periodically or when a predetermined number of items have been added to the map.

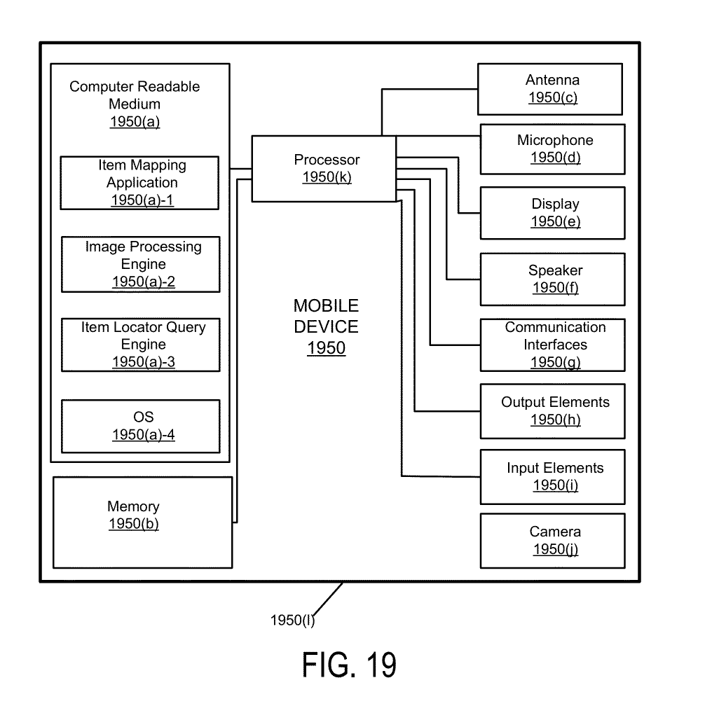

FIG. 19 is a functional block diagram of a mobile device 1950 according to an embodiment of the present invention. As shown in FIG. 19, the mobile device 1950 may be in the form of cellular phone, having a display 1950(e) and input elements 1950(i) to allow a user to input information into the device 1950 (e.g., via a keyboard), and memory 1950(b). The mobile device 1950 can also include a processor 1950(k) (e.g., a microprocessor) for processing the functions of the mobile device 1950, at least one antenna 1950(c) for wireless data transfer, a microphone 1950(d) to allow the user to transmit his/her voice through the mobile device 1950, and speaker 1950(f) to allow the user to hear voice communication, music, etc. In addition, the mobile device 1950 may include one or more interfaces in addition to antenna 1950(c), e.g., a wireless interface coupled to an antenna. The communications interfaces 1950(g) can provide a near field communication interface (e.g., contactless interface, Bluetooth, optical interface, etc.) and/or wireless communications interfaces capable of communicating through a cellular network, such as GSM, or through WiFi, such as with a wireless local area network (WLAN). Accordingly, the mobile device 1950 may be capable of transmitting and receiving information wirelessly through both short range, radio frequency (RF) and cellular and WiFi connections. Additionally, the mobile device 1950 can be capable of communicating with a Global Positioning System (GPS) in order to determine to location of the mobile device. In the embodiment shown in FIG. 19, antenna 1950(c) may comprise a cellular antenna (e.g., for sending and receiving cellular voice and data communication, such as through a network such as a 3G or 4G network), and interfaces 1950(g) may comprise one or more local communication interfaces. In other embodiments contemplated herein, communication with the mobile device 1950 may be conducted with a single antenna configured for multiple purposes (e.g., cellular, transactions, etc.), or with further interfaces (e.g., three, four, or more separate interfaces).

The mobile device 1950 can also include a computer readable medium 1950(a) coupled to the processor 1950(k), which stores application programs and other computer code instructions for operating the device, such as an operating system (OS) 1950(a)-4. In an embodiment of the present invention, the computer readable medium 1950(a) can include an item mapping application 1950(a)-1. The item mapping application can automatically run each time that a user accesses the application, such as illustrated in FIG. 13. In some embodiments, the item mapping application 1950(a)-1 can run continuously (e.g., in the background) or at other times, such as when an image is captured and/or stored on the mobile device. In addition, the application can include a customizable user interface (UI), which can be determined by the user's preferences through application level programming. The application can be used to display and manage the captured item images and maps of merchant locations as well as to enter product queries to locate a map and/or directions to a specified item.

Referring again to FIG. 19, the computer readable medium 1950(a) can also include an image processing engine 1950(a)-2. The image processing engine 1950(a)-2 can capture an image and compress the image in a format readable by the central processing server. Additionally, the image processing engine 1950(a)-2 can append location information of the mobile device 1950 to an image transmitted to the central processing server. The location information can include, e.g., coordinates of the mobile device 1950. Both the coordinates and the image can be stored by the memory 1950(b) of the mobile device 1950.

The computer readable medium 1950(a) on the mobile device 1950 can also include an item locator query engine 1950(a)-3, which allows a user to enter a word or phrase to locate an item. In some embodiments, the item is searched from a listing of items on a recently stored map of a merchant location. In other embodiments, the item is sent to the central processing server, which performs a search using an associated database. In other embodiments, the image captured by a user is utilized by the item locator query engine to locate one or more items within the image.

The mobile device 1950 can additionally include an integrated camera 1950(j), capable of capturing images and/or video. In certain embodiments, the mobile device 1950 may include a non-transitory computer readable storage medium, e.g., memory 1950(b), for storing images captured with the camera 1950(j). In alternative embodiments, the mobile device 1950 receives image data from an image capture device that is not integrated with the mobile device 1950 and stores those images on the aforementioned non-transitory storage medium.

Some benefits of various embodiments of the invention allow a user to easily locate and access item information by entering a query for an item using either an image captured using the user's mobile device or using a previously captured image. Some embodiments of the present invention also allow multiple users to provide item information to a central database and processing server in order to maintain, map and manage items within a merchant location.

The software components or functions described in this application may be implemented as software code to be executed by one or more processors using any suitable computer language, such as, for example, Java, C++, or Perl, using, for example, conventional or object-oriented techniques. The software code may be stored as a series of instructions, or commands on a computer-readable medium, such as a random access memory (RAM), a read-only memory (ROM), a magnetic medium, such as a hard-drive or a floppy disk, or an optical medium, such as a CD-ROM. Any such computer-readable medium may also reside on or within a single computational apparatus, and may be present on or within different computational apparatuses within a system or network.

Aspects of the disclosure can be implemented in the form of control logic in software or hardware or a combination of both. The control logic may be stored in an information storage medium as a plurality of instructions adapted to direct an information processing device to perform a set of steps disclosed herein. Based on the disclosure and teachings provided herein, a person of ordinary skill in the art will appreciate other ways and/or methods to implement the present invention.

For example, in some additional and/or alternative embodiments, a server computer may be configured to receive plural messages from a plurality of image capturing devices, where each message includes an image including at least one product or good, and information identifying a first location at which the first image was captured. The server computer may be further configured to analyze the received images to identify the products or goods included in those images. And, the server computer may be configured to store, in at least one database, information identifying the products or goods identified in the received images along with the locations of those products or goods.

In other additional and/or alternative embodiments, a method may comprise receiving plural messages from a plurality of image capturing devices, where each message includes an image including at least one product or good, and information identifying a first location at which the first image was captured. The method may further comprise analyzing the received images to identify the products or goods included in those images. In addition, the method may comprise storing, in at least one database, information identifying the products or goods identified in the received images along with the locations of those products or goods.

In some embodiments, any of the entities described herein may be embodied by a computer that performs any and/or all of the functions and steps disclosed. In addition, one or more features from any embodiment may be combined with one or more features of any other embodiment without departing from the scope of the invention.

Any recitation of “a,” “an,” or “the” is intended to mean “one or more” unless specifically indicated to the contrary.

The above described is illustrative and is not restrictive. Many variations of aspects of the disclosure will become apparent to those skilled in the art upon review of the disclosure. The scope of the disclosure should, therefore, be determined not with reference to the above description, but instead should be determined with reference to the appended claims along with their full scope or equivalents.

What is claimed is:

1. A method, comprising:
receiving, by a server computer, from a first computing device, a first image and information identifying a first location at which the first image was captured, the first image including a first product;
receiving, by the server computer, from a second computing device, a second image and information identifying a second location at which the second image was captured, the second image including a second product, the second location being different from the first location;
analyzing, by the server computer, the first image to identify the first product;
analyzing, by the server computer, the second image to identify the second product;
storing, by the server computer, in at least one database, first information associating the first product with the first location; and
storing, by the server computer, in the at least one database, second information associating the second product with the second location.

2. The method of claim 1, further comprising:
generating, by the server computer, based on information stored in the at least one database, mapping data describing locations of one or more products located at the first location.

3. The method of claim 2, wherein the mapping data is used in navigating a first user of the first computing device to a particular product located at the first location.

4. The method of claim 1,
wherein the first location is a first store operated by a first entity, and
wherein the second location is a second store operated by a second entity different from the first entity.

5. The method of claim 1,
wherein the first computing device is used by a first user, and
wherein the second computing device is used by a second user different from the first user.

6. The method of claim 1, wherein the at least one database is configured to store crowd-sourced product information.

7. The method of claim 1, wherein the first computing device is a mobile device used by a customer at the first location.

8. The method of claim 1, wherein the first computing device is a surveillance camera deployed at the first location.

9. The method of claim 1, wherein the first computing device is a robotic device deployed at the first location.

10. The method of claim 1, further comprising:
receiving, by the server computer, payment information associated with a transaction completed at the first location, the payment information including a transaction amount and information identifying a payor;
determining, based on information stored in the at least one database and the payment information, one or more products purchased by the payor in the transaction; and
storing, by the server computer, in the at least one database, third information associating the payor with the one or more products purchased by the payor in the transaction.

11. A method comprising:
capturing, by a computing device, a first image at a first location, the first image including a first product; and
providing, by the computing device, the first image and information identifying the first location to at least one server computer,
wherein the at least one server computer is configured to analyze the first image, identify the first product, and store information identifying the first product and the information identifying the first location in at least one database.

12. The method of claim 11, further comprising:
receiving, by the computing device, from the at least one server computer, mapping data describing locations of one or more products located at the first location; and
displaying, by the computing device, based on the mapping data, a map of the first location.

13. The method of claim 12, further comprising:
receiving, by the computing device, a query for a second product;
determining, by the computing device, based on the mapping data, a location of the second product; and
providing, by the computing device, navigation instructions from a current location to the location of the second product.

14. The method of claim 11, wherein capturing the first image at the first location includes determining a current location of the computing device based on sensor data received from one or more sensors included in the computing device.

15. The method of claim 14, wherein the one or more sensors include at least one accelerometer, at least one gyroscope, at least one magnetometer, and at least one Global Positioning System (GPS) receiver.

16. The method of claim 11, further comprising:
prior capturing the first image at the first location, providing, by the computing device, at least one incentive to a user of the computing device to capture the first image.

17. The method of claim 16, wherein the at least one incentive is a coupon.

18. The method of claim 16, wherein the at least one incentive is associated with a scavenger hunt.

19. The method of claim 11, further comprising:
in response to capturing the first image at the first location, providing, by the computing device, a coupon for the first product.

20. The method of claim 11, further comprising:
in response to capturing the first image at the first location, providing, by the computing device, a coupon for a second product, wherein the coupon is configured to steer a user of the computing device to a second location different from the first location.

21. The method of claim 11, further comprising:
in response to capturing the first image at the first location, providing, by the computing device, a payment interface configured to enable a user of the computing device to purchase the first product.

22. A server computer comprising:
at least one processor; and
memory storing computer-readable instructions that, when executed by the at least one processor, cause the server computer to:
receive, from a first computing device, a first image and information identifying a first location at which the first image was captured, the first image including a first product;
receive, from a second computing device, a second image and information identifying a second location at which the second image was captured, the second image including a second product, the second location being different from the first location;
analyze the first image to identify the first product;
analyze the second image to identify the second product;
store, in at least one database, first information associating the first product with the first location; and
store, in the at least one database, second information associating the second product with the second location.

23. The server computer of claim 22,
wherein the first location is a first store operated by a first entity, and
wherein the second location is a second store operated by a second entity different from the first entity.

24. The server computer of claim 22, wherein the memory stores additional computer-readable instructions that, when executed by the at least one processor, further cause the server computer to:
receive payment information associated with a transaction completed at the first location, the payment information including a transaction amount and information identifying a payor;
determine, based on information stored in the at least one database and the payment information, one or more products purchased by the payor in the transaction; and
store, in the at least one database, third information associating the payor with the one or more products purchased by the payor in the transaction.
